(19) United States
(12) Patent Application Publication
(10) Pub. No.: US 2022/0134880 A1
(43) Pub. Date: May 5, 2022

(54) Vehicle Control System and Control Method of Vehicle

(71) Applicants: Hyundai Motor Company, Seoul (KR); Kia Corporation, Seoul (KR)

(72) Inventors: Kyung Chul Lee, Seongnam-si (KR); Jaemin Joh, Yongin-si (KR)

(21) Appl. No.: 17/490,171

(22) Filed: Sep. 30, 2021

(30) Foreign Application Priority Data
Nov. 4, 2020 (KR) 10-2020-0146280

(51) Int. Cl. B60K 35/00; G06K 9/00; G06K 9/46; G06F 3/16; G06F 16/332

(52) U.S. Cl. CPC B60K 35/00; G06K 9/00832; G06K 9/46; G06F 3/167; B60K 2370/157; B60K 2370/152; B60K 2370/148; B60K 2370/21; G06F 16/3329

(57) ABSTRACT

An embodiment vehicle control system includes a display, a microphone configured to acquire a user's voice, a memory configured to store a dialog model related to a sign in a vehicle, and a processor configured to identify a question about the sign in the vehicle in the user's voice, determine a response corresponding to the question about the sign using the dialog model, and control the display to output the determined response.

### CROSS-REFERENCE TO RELATED APPLICATIONS

This application claims the benefit of Korean Patent Application No. 10-2020-0146280, filed on Nov. 4, 2020 in the Korean Intellectual Property Office, which application is hereby incorporated herein by reference.

### TECHNICAL FIELD

The disclosure relates to a vehicle control system and a control method of a vehicle.

### BACKGROUND

Ordinary drivers are often unaware of the information and many functions provided by a vehicle. In particular, it is not easy to recognize and respond to information on various warnings of the vehicle while driving.

A lot of information about the vehicle is provided through the vehicle's instrument cluster or audio/video/navigation (AVN) device. For example, many signs are being displayed on instrument clusters and AVN devices. However, many drivers do not clearly know the names or meanings of the signs. In order to understand the meaning of the signs, the driver must refer to the manual or conduct a separate search.

Although voice recognition technology has been developed, there are not many voice recognition technologies related to vehicle information, and only limited services are provided. In addition, if the user does not know the exact names of signs existing inside the vehicle, it is difficult to obtain an accurate answer through voice recognition technology.

### SUMMARY

The disclosure relates to a vehicle control system and a control method of a vehicle. Particular embodiments relate to a vehicle control system and a control method of a vehicle for providing information about a sign in a vehicle to a user using a voice recognition technology.

Therefore, an embodiment of the present disclosure provides a vehicle control system that can efficiently and accurately provide information about a sign in a vehicle to a user using a voice recognition technology, and a control method of a vehicle.

In accordance with one embodiment of the disclosure, a vehicle control system includes a display, a microphone configured to acquire a user's voice, a memory configured to store a dialog model related to a sign in a vehicle, and a processor configured to identify a question about the sign in the vehicle in the user's voice, determine a response corresponding to the question about the sign using the dialog model, and control the display to output the determined response.

The processor may be configured to identify a characteristic word about the sign in the question about the sign, and determine the response matching the characteristic word using the dialog model.

The vehicle control system may further include a camera configured to acquire an image related to the sign in the vehicle, and the processor may be configured to identify the sign from the image, and generate the dialog model about the sign in the vehicle using the identified sign and a vehicle information database stored in the memory.

The processor may be configured to extract a characteristic of the identified sign, and extract vehicle information corresponding to the characteristic of the sign from the vehicle information database.

The processor may be configured to generate a text representing the characteristic of the extracted sign, and search the vehicle information associated with the text representing the characteristic of the sign in the vehicle information database.

The processor may be configured to generate the dialog model about the sign in the vehicle based on the searched vehicle information and the text representing the characteristic of the sign.

The processor may be configured to extract at least one of color, shape, location or boundary of the identified sign as a characteristic of the sign.

The processor may be configured to update the dialog model based on the question and the response about the sign.

The vehicle information database may include a cluster information database, an AVN setting database and a vehicle manual database.

In accordance with one embodiment of the disclosure, a control method of a vehicle includes acquiring a user's voice through a microphone provided in the vehicle, identifying, by a processor, a question about a sign in the vehicle in the user's voice, determining, by the processor, a response corresponding to the question about the sign using a dialog model, and controlling, by the processor, a display provided in the vehicle to output the determined response.

The determining the response corresponding to the question about the sign using the dialog model may include identifying a characteristic word about the sign in the question about the sign and determining the response matching the characteristic word using the dialog model.

The control method may further include acquiring an image related to the sign in the vehicle by a camera provided in the vehicle, identifying the sign from the image, and generating the dialog model about the sign in the vehicle using the identified sign and a vehicle information database stored in the memory.

The generating the dialog model may include extracting a characteristic of the identified sign and extracting vehicle information corresponding to the characteristic of the sign from the vehicle information database.

The extracting vehicle information corresponding to the characteristic of the sign may include generating a text representing the characteristic of the extracted sign and searching the vehicle information associated with the text representing the characteristic of the sign in the vehicle information database.

The generating the dialog model may be performed based on the text representing the characteristic of the sign and the searched vehicle information.

The extracting the characteristic of the identified sign may include extracting at least one of color, shape, location or boundary of the identified sign.

The control method may further include updating the dialog model based on the question and the response about the sign.

The vehicle information database may include a cluster information database, an AVN setting database and a vehicle manual database.

### BRIEF DESCRIPTION OF THE DRAWINGS

These and/or other embodiments of the disclosure will become apparent and more readily appreciated from the following description of exemplary embodiments, taken in conjunction with the accompanying drawings, in which:

FIG. 1 is a view showing the interior of a vehicle;

FIG. 2 illustrates an example of signs displayed in a cluster;

FIG. 3 illustrates an example of signs displayed on an AVN device;

FIG. 4 illustrates an example of signs displayed on an input device;

FIG. 5 is a block diagram of a configuration of a vehicle control system according to an embodiment;

FIG. 6 illustrates functional blocks performed by a processor according to an embodiment;

FIG. 7 illustrates an example of databases stored in a memory according to an embodiment;

FIG. 8 is a flowchart of a control method of a vehicle according to an embodiment;

FIG. 9 is a flowchart illustrating generation of a dialog model used in a vehicle control system according to an embodiment;

FIG. 10 is a table for illustrating the extraction of the characteristic of the sign in the vehicle;

FIG. 11 illustrates an example of information stored in the cluster information database;

FIG. 12 illustrates an example of information stored in the AVN information database;

FIG. 13 illustrates an example of information stored in the vehicle manual database;

FIG. 14 illustrates an example of information stored in the dialog model database;

FIG. 15 illustrates an example of a screen displayed on a display by a control method of a vehicle according to an embodiment; and

FIG. 16 illustrates another example of a screen displayed on a display by a control method of a vehicle according to an embodiment.

### DETAILED DESCRIPTION OF ILLUSTRATIVE EMBODIMENTS

Like reference numerals refer to like elements throughout the specification. Not all elements of embodiments of the disclosure will be described, and description of what are commonly known in the art or what overlap each other in the embodiments will be omitted.

It will be understood that when an element is referred to as being “connected” to another element, it can be directly or indirectly connected to the other element, wherein the indirect connection includes “connection” via a wireless communication network.

Also, when a part “includes” or “comprises” an element, unless there is a particular description contrary thereto, the part may further include other elements, not excluding the other elements.

As used herein, the singular forms “a,” “an” and “the” are intended to include the plural forms as well, unless the context clearly indicates otherwise.

As used herein, the terms “portion,” “unit,” “block,” “member,” and “module” refer to a unit that can perform at least one function or operation. For example, these terms may refer to at least one process which is performed by at least one piece of hardware such as a field-programmable gate array (FPGA) and an application specific integrated circuit (ASIC), and at least one piece of software stored in a memory or a processor.

An identification code is used for the convenience of the description but is not intended to illustrate the order of each step. Each of the steps may be implemented in an order different from the illustrated order unless the context clearly indicates otherwise.

Hereinafter, embodiments of the present disclosure will be described in detail with reference to the accompanying drawings.

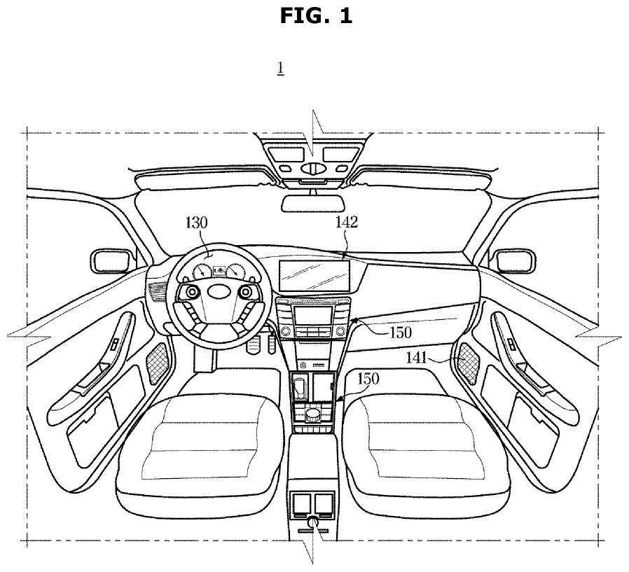

FIG. 1 is a view showing the interior of a vehicle.

Referring to FIG. 1, the interior of a vehicle 1 may include a seat, a dashboard, and an instrument panel (cluster 130). The instrument panel (cluster 130) is disposed on the dashboard, and may include various indicator lights and warning lights. For example, the cluster 130 may include a tachometer, a speedometer, a coolant thermometer, a fuel gauge, a turn indicator, a high beam indicator, a warning light, a seat belt warning light, an odometer, a tachograph, an automatic shift selection lever indicator, a door open warning light, an engine oil warning light, and a low fuel warning light. Also, the cluster 130 may include a display and may be implemented digitally. The digitally implemented cluster 130 may display vehicle state information and driving information as images.

Also, the vehicle 1 may include AVN devices 141 and 142 and an input device 150. The AVN devices 141, 142 will be referred to collectively as AVN device 140, which label is not explicitly shown in the figures. The AVN device 140 and the input device 150 may be provided in the center fascia.

The AVN device 140 may output various types of information related to the function and state of the vehicle 1. The AVN device 140 may include a speaker 141 and a display 142. The speaker 141 may include at least one speaker installed on a dashboard, a door, or the like. The display 142 may be a light emitting diode (LED) panel, an organic light emitting diode (OLED) panel, or a liquid crystal display (LCD) panel. Also, the display 142 may include a touch screen. The display 142 may be provided at various positions in the vehicle.

The input device 150 may include at least one of buttons, dials, and touchpads related to various functions of the vehicle 1 provided on the center fascia, the head unit, and the steering wheel. For example, the input device 150 may be implemented as a physical button, a knob, a touch pad, a touch screen, a stick-type manipulation device, or a track ball.

The vehicle 1 may further include a power generating device, a power transmitting device, a driving assistance device, a steering device, a braking device, an accelerator device, a suspension device, a transmission device, a fuel device, a wheel, and a battery.

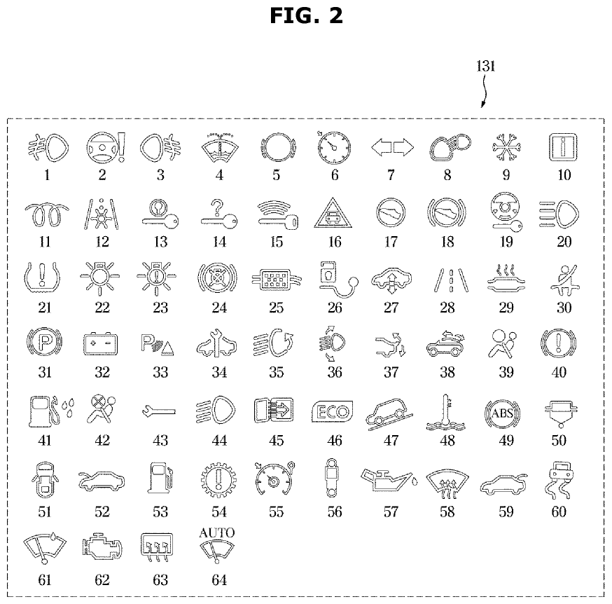

FIG. 2 illustrates an example of signs displayed in a cluster.

Referring to FIG. 2, the cluster 130 may include an indicator indicating the vehicle state. Indicators included in the cluster 130 are indicated by various signs 131. The meaning of each sign displayed on the cluster 130 is as follows.

The 1 indicates front fog light, 2 indicates power steering warning, 3 indicates rear fog light, 4 indicates low washer fluid warning, 5 indicates brake pad warning, 6 indicates cruise on, 7 indicates turn signal, 8 indicates rain and light detector, 9 indicates winter mode, 10 indicates information indicator, 11 indicates preheat plug/diesel preheat warning, 12 indicates frost warning, 13 indicates ignition switch warning, 14 indicates key missing, 15 indicates electronic key low battery, 16 indicates distance between the vehicles warning, 17 indicates clutch pedal depressed, 18 indicates brake pedal depressed, 19 indicates steering lock, 20 indicates headlight, 21 indicates insufficient tire pressure, 22 indicates sidelight information, 23 indicates faulty exterior light, 24 indicates brake light alarm, 25 indicates diesel exhaust gas after treatment device alarm, 26 indicates trailer tow warning, 27 indicates air suspension warning, 28 indicates lane departure warning, 29 indicates catalytic converter warning, 30 indicates seat belt not worn warning, 31 indicates parking brake light, 32 indicates battery warning, 33 indicates parking assist device on, 34 indicates service request, such as oil change, 35 indicates automatic headlights, 36 indicates headlight range adjuster, 37 indicates rear spoiler warning, 38 indicates convertible ceiling warning, 39 indicates airbag warning, 40 indicates hand brake warning, 41 indicates water in fuel filter, 42 indicates airbag deactivated, 43 indicates fault problem, 44 indicates low headlights, 45 indicates dirty air filter, 46 indicates eco driving indicator, 47 indicates downhill control, 48 indicates temperature warning, 49 indicates anti-lock brake system (ABS) warning, 50 indicates fuel filter warning, 51 indicates door open, 52 indicates bonnet (hood) open, 53 indicates low fuel, 54 indicates automatic gearbox warning, 55 indicates speed limiter, 56 indicates suspension regulator, 57 indicates insufficient engine oil pressure, 58 indicates windshield defrost, 59 indicates trunk opening, 60 indicates Electronic Stability Program (ESP), 61 indicates rain sensor, 62 indicates engine emission warning, 63 indicates rear window defrost, and 64 indicates automatic wiper operation.

In addition, the red sign indicates a danger warning and indicates a warning directly related to the safety of the occupants. For example, a red warning light turns on when the brake is faulty or when the engine oil is insufficient. A yellow sign indicates that it may be driven but is dangerous if left unattended for a long time. The green or blue sign indicates the current state of the vehicle, and indicates what function is currently being performed.

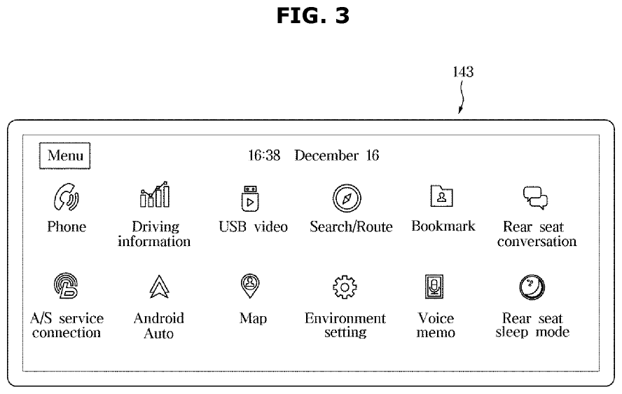

FIG. 3 illustrates an example of signs displayed on an AVN device.

Referring to FIG. 3, the display 142 of the AVN device 140 may output a screen 143 including a sign such as an icon for executing or setting various functions of the vehicle 1. On the screen 143 of the display 142, the name of the corresponding icon may be displayed together with the icon image. For example, the display 142 may display an icon indicating a phone function, a driving information display function, a USB video function, a route search function, a bookmark, a rear seat conversation function, an A/S service connection function, an Android auto function, a map display function, an environment setting, a voice memo function and a rear seat sleep mode.

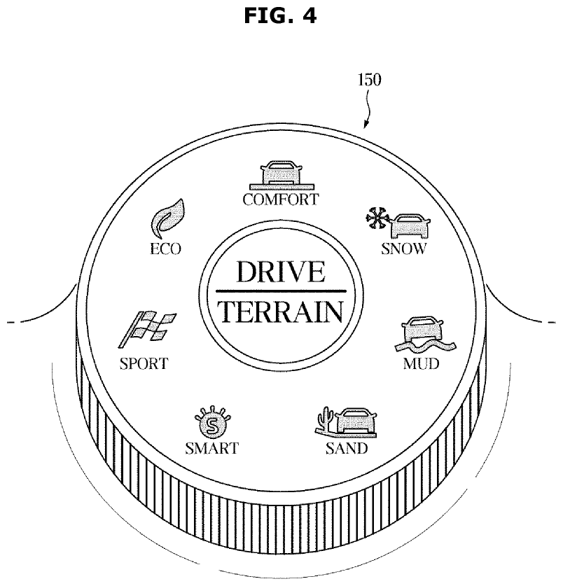

FIG. 4 illustrates an example of signs displayed on an input device.

Referring to FIG. 4, the input device 150 is illustrated as a dial. A user may select a desired function or mode by turning the input device 150. A sign related to the function or mode of the vehicle 1 may be displayed on the input device 150. For example, the input device 150 may display a comfort mode sign, an eco mode sign, a sports mode sign, a snow mode sign, a mud mode sign, and a sand mode sign as signs related to the driving mode of the vehicle 1.

As shown in FIGS. 2, 3 and 4, a number of signs may be displayed on the device inside the vehicle 1. However, there is a problem in that it is difficult for the user to intuitively understand these signs. Embodiments of the present disclosure efficiently and accurately provide information about signs in the vehicle to users using voice recognition technology.

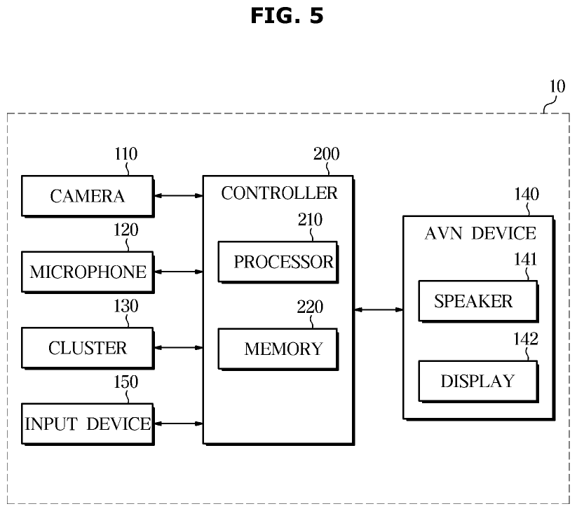

FIG. 5 is a block diagram of a configuration of a vehicle control system according to an embodiment.

Referring to FIG. 5, the vehicle control system 10 may include a camera 110, a microphone 120, a cluster 130, an AVN device 140, an input device 150, and a controller 200. The controller 200 may be electrically connected to the components of the vehicle control system 10 and control each component.

The camera 110 is provided inside the vehicle 1 and may acquire an image regarding a sign existing inside the vehicle 1. For example, the camera 110 may be installed on the ceiling of the vehicle 1. The camera 110 may photograph a sign displayed on the cluster 130, the AVN device 140, and the input device 150, and acquire an image. The controller 200 may control the camera 110 to periodically acquire an image every predetermined time. Also, the controller 200 may control the camera 110 to acquire an image when a user's voice is input through the microphone 120.

The microphone 120 is provided inside the vehicle 1 and may acquire the user's voice. The microphone 120 may be provided at various locations in the vehicle 1. For example, the microphone 120 may be installed on a steering wheel, a headrest of a seat, or the like.

The cluster 130 may include various indicator lights and warning lights. The cluster 130 may display vehicle state information and driving information.

The AVN device 140 may output various types of information related to the function and state of the vehicle 1. The AVN device 140 may include a speaker 141 and a display 142.

The input device 150 may include at least one of buttons, dials, and touchpads related to various functions of the vehicle 1.

The controller 200 may include a processor 210 and a memory 220. The memory 220 may store programs, instructions, and/or applications related to the operation of the vehicle control system 10. Also, the memory 220 may store vehicle information. The processor 210 may execute a program stored in the memory 220. The processor 210 and the memory 220 may be integrated into one chip. In addition, the processor 210 and the memory 220 may be provided in physically separated locations. In addition, the processor 210 and the memory 220 may be provided in plurality, respectively.

The memory 220 may include a non-volatile memory element such as cache, read only memory (ROM), programmable ROM (PROM), erasable programmable ROM (EPROM), electrically erasable programmable ROM (EEPROM), and flash memory. Further, the memory 220 may include a volatile memory element such as random access memory (RAM), and may include a storage medium such as a hard disk drive (HDD) or a CD-ROM. The type of the memory 220 is not limited to what is illustrated.

The vehicle 1 may further include a transceiver (not shown). The transceiver may transmit/receive data to and from an external device. For example, the transceiver may communicate with the server to transmit/receive data. The transceiver may be a communication circuit to which various communication technologies are applicable. The transceiver may receive data from the outside using a wireless communication technology such as Vehicle-to-Vehicle (V2V) communication, Wi-Fi, Wireless Local Area Network (WLAN), Ultra-Mobile Broadband (UMB), GPS, and Long Term Evolution (LTE).

In addition, the vehicle control system 10 may further include various configurations.

Hereinafter, the operation of the vehicle control system 10 will be described in detail.

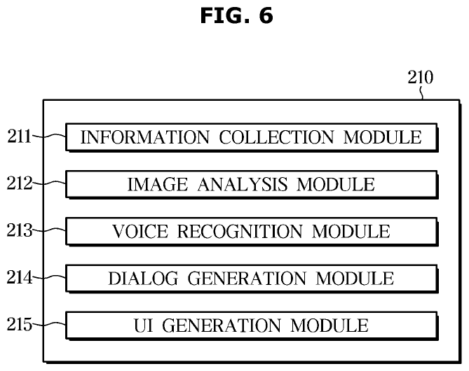

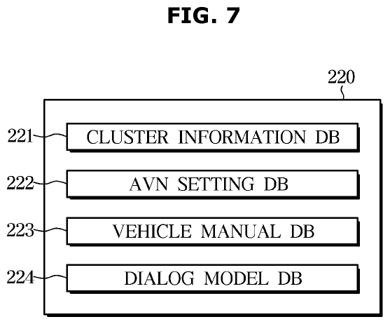

FIG. 6 illustrates functional blocks performed by a processor according to an embodiment. FIG. 7 illustrates an example of databases stored in a memory according to an embodiment.

Referring to FIG. 6, the processor 210 of the controller 200 may include an information collection module 211, an image analysis module 212, a voice recognition module 213, a dialog generation module 214, and a UI generation module 215.

Referring to FIG. 7, the memory 220 of the controller 200 may include a cluster information database 221, an AVN setting database 222, a vehicle manual database 223, and a dialog model database 224. The cluster information database 221, the AVN setting database 222, and the vehicle manual database 223 may be defined to be included in the vehicle information database.

The cluster information database 221 may include information of a sign displayed on the cluster 130. The information of the sign may include information about classification, image, name, color and shape. The AVN setting database 222 may include information about images, names, colors, and shapes of signs displayed on the display 142 of the AVN device 140. The vehicle manual database 223 may include a description of a sign inside the vehicle 1. The dialog model database 224 may store a dialog model. The dialog model may include a question about a sign in the vehicle and a response corresponding to the question.

Referring back to FIG. 6, the information collection module 211 may collect an image or text related to a sign in a vehicle. The information collection module 211 may acquire an image about a sign in the vehicle from the camera 110. The information collection module 211 may obtain text about the sign from the database stored in the memory 220. The information collection module 211 may periodically collect images or texts at predetermined time intervals. Also, the information collection module 211 may acquire an image or text when a user's voice is input through the microphone 120.

The image analysis module 212 may identify the sign from the image acquired by the camera no. The image analysis module 212 may extract characteristics of the identified sign. In addition, the image analysis module 212 may generate text representing the characteristics of the extracted sign. The image analysis module 212 may extract at least one of color, shape, location or boundary of the identified sign as a characteristic of the sign.

The voice recognition module 213 may analyze the user's voice input through the microphone 120 and identify a question about a sign in the vehicle included in the user's voice. Specifically, the voice recognition module 213 may identify a characteristic word about the sign in the question about the sign. In addition, the voice recognition module 213 may convert a question about a sign in the vehicle into text.

The dialog generation module 214 may determine a response corresponding to the question about the sign using the dialog model stored in the memory 220. The dialog generation module 214 may determine a response matching the characteristic word included in the user's voice. In addition, the dialog generation module 214 may generate a dialog model based on the content analyzed by the voice recognition module 213 and the vehicle information database. The dialog generation module 214 may update the dialog model stored in the memory 220 based on the question and response regarding the sign.

The user interface (UI) generation module 215 may control the display 142 to output the determined response. The UI generation module 215 may generate a graphical user interface (GUI) appropriate for the determined response. A graphical user interface (GUI) generated by the UI generation module 215 may include at least one of an image and text. The display 142 may output the generated GUI.

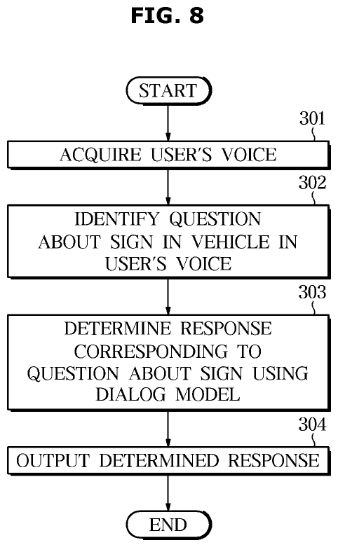

FIG. 8 is a flowchart of a control method of a vehicle according to an embodiment.

Referring to FIG. 8, the microphone 120 of the vehicle control system 10 according to an embodiment may acquire a user's voice (301). The processor 210 of the vehicle control system 10 may identify a question about the sign in the vehicle in the user's voice (302). The processor 210 may determine a response corresponding to the question about the sign using the dialog model (303). The processor 210 may identify the characteristic word about the sign in the question about the sign, and determine a response matching the characteristic word using a dialog model. Also, the processor 210 may control the AVN device 140 to output the determined response (304).

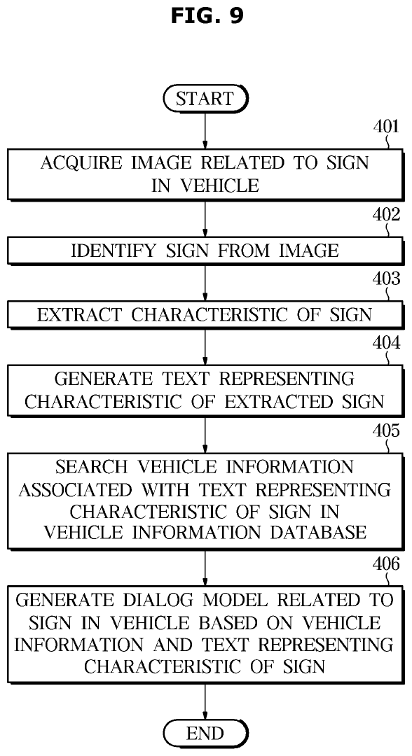

FIG. 9 is a flowchart illustrating generation of a dialog model used in a vehicle control system according to an embodiment.

Referring to FIG. 9, the camera no of the vehicle control system 10 may acquire an image related to a sign in the vehicle (401). The processor 210 may identify a sign from the image (402). The processor 210 may generate the dialog model related to the sign in the vehicle using the identified sign and the vehicle information database stored in the memory 220.

The processor 210 may extract the characteristic of the identified sign (403). The processor 210 may extract at least one of a color, a shape, a location, or a boundary of the identified sign as a characteristic of the sign. The processor 210 may generate text representing the characteristic of the extracted sign (404).

The processor 210 may extract vehicle information corresponding to the characteristic of the sign from the vehicle information database stored in the memory 220. The vehicle information may include sign information displayed on the cluster 130, sign information displayed on the display 142 of the AVN device 140, keyword information related to the AVN device 140, and vehicle manual information. Specifically, the processor 210 may search vehicle information associated with the text representing the characteristic of the sign in the vehicle information database (405).

The processor 210 may generate a dialog model related to the sign in the vehicle based on the searched vehicle information and the text representing the characteristic of the sign (406). The processor 210 may update the dialog model based on the question and response regarding the sign.

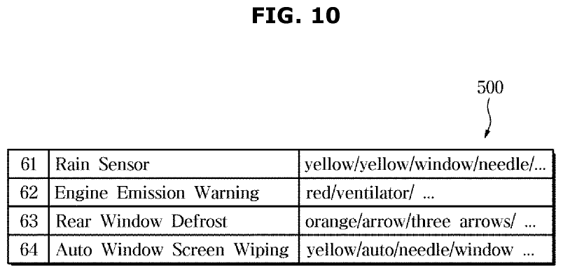

FIG. 10 is a table for illustrating the extraction of the characteristic of the sign in the vehicle.

Referring to the table 500 of FIG. 10, the processor 210 of the vehicle control system 10 may identify a sign from an image acquired by the camera no and extract characteristics of the sign. For example, number 61 indicates rain sensor, number 62 indicates engine emission warning, number 63 indicates rear windshield defrost, number 64 indicates automatic wiper operation. The processor 210 may extract yellow, a window shape, and a needle shape as a characteristic of the rain sensor sign 61. The processor 210 may generate text indicating a yellow color, a window shape, and a needle shape, and store the generated text in the memory 220 by associating the generated text with the rain sensor sign 61.

The processor 210 may extract red and a ventilator shape as a characteristic of the engine emission warning sign 62. The processor 210 may generate a text representing a red color and a ventilator shape, and associate the generated text with the engine emission warning sign 62 and store it in the memory 220.

In addition, the processor 210 may extract an orange color, an arrow shape and three arrows as a characteristic of the rear glass defrost sign 63. The processor 210 may generate an orange color, an arrow shape, and three arrows, and store the generated text in the memory 220 by associating the generated text with the rear glass defrosting sign 63.

In addition, the processor 210 may extract yellow, an AUTO character, a needle shape and a window shape as a characteristic of the automatic wiper operation sign 64. The processor 210 may generate text representing yellow, AUTO lettering, a needle shape, and a window shape, and associate the generated text with the automatic wiper operation sign 64 and store it in the memory 220.

What has been described in FIG. 10 corresponds to an example, and the processor 210 may extract the characteristic of another sign and store it as text. The processor 210 may find vehicle information matching the characteristic of the sign stored as text in the database of the memory 220. The processor 210 may generate a dialog model by associating the characteristic of the sign and vehicle information.

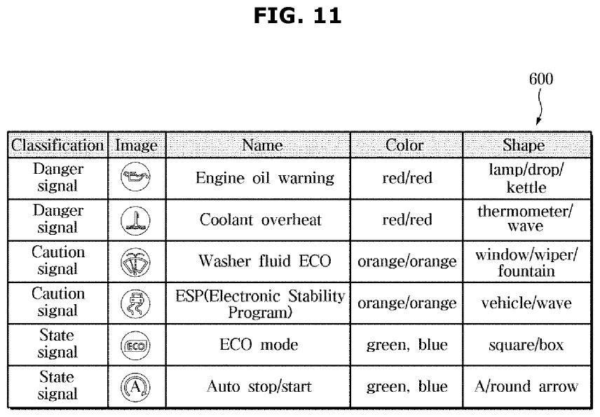

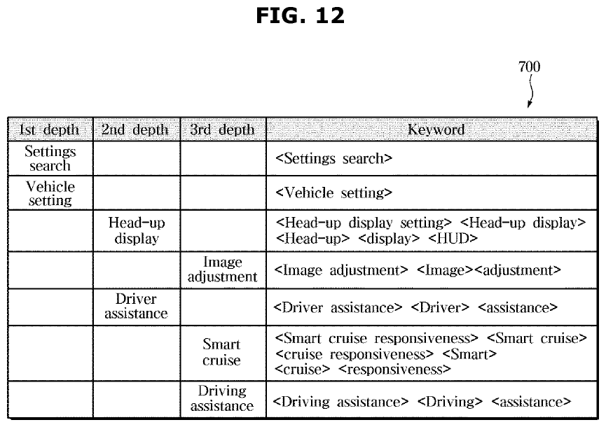

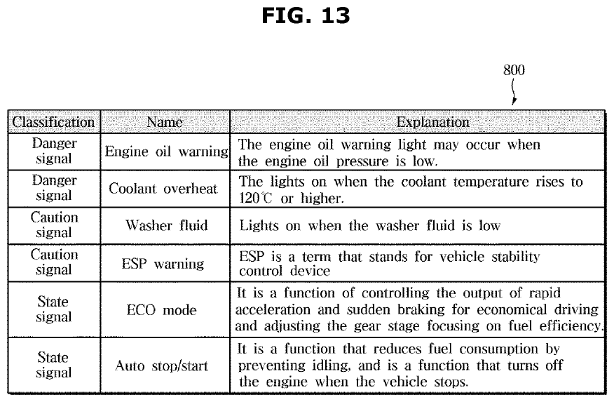

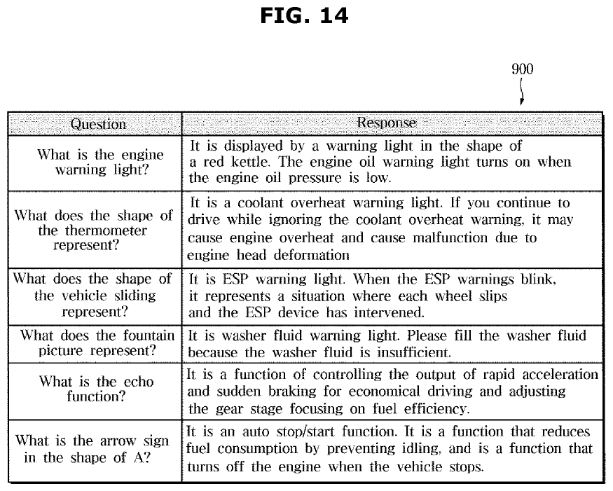

FIG. 11 illustrates an example of information stored in the cluster information database. FIG. 12 illustrates an example of information stored in the AVN information database. FIG. 13 illustrates an example of information stored in the vehicle manual database. FIG. 14 illustrates an example of information stored in the dialog model database.

Referring to FIG. 11, the cluster information database 221 may include information 600 of a sign displayed on the cluster 130. The information of the sign may include information about classification, image, name, color and shape. Information about the classification, name, color, and shape of the signs displayed in the cluster 130 may be stored as text. For example, information about a sign indicating an engine oil warning may be stored as a danger signal, engine oil warning, red, lamp shape/drop shape/kettle shape. Information on the coolant overheat sign, washer fluid sign, ESP sign, eco mode sign, and auto stop/start sign may also be stored as shown in FIG. 11.

Referring to FIG. 12, the AVN setting database 222 may include keyword information 700 related to various functions. When a user's voice including a specific keyword is received through the microphone 120, the processor 210 may extract a keyword included in the user's voice and execute a vehicle function corresponding to the extracted keyword. For example, the keyword related to the setting search function may be ‘setting search’, and the keyword related to the vehicle setting function may be ‘vehicle setting’. Also, keywords related to the head-up display setting function may include ‘head-up display setting’, ‘head-up display’, ‘head-up’, ‘display’, and ‘HUD’. Also, keywords related to each of the image adjustment function, the driver assistance function, the smart cruise function, and the driving assistance function may be exemplified as shown in FIG. 12.

In addition, the AVN setting database 222 may include information about the image, name, color, and shape of the sign displayed on the AVN device 140. Information on names, colors, and shapes of signs displayed on the AVN device 140 may be stored as text. For example, information about a sign of a phone function may include a white color and a phone shape.

Referring to FIG. 13, the vehicle manual database 223 may include a description 800 of a sign inside the vehicle 1. The description 800 for the sign may be stored as text. For example, the description of the engine oil warning light may be stored in the vehicle manual database 223 such as “The engine oil warning light may occur when the engine oil pressure is low”. A description of the overheating of the coolant may be stored as “lights on when the coolant temperature rises to 120° C. or higher.” A description of the ESP warning, a description of a washer fluid warning, a description of the eco mode, and a description of the auto stop/start may also be stored as shown in FIG. 13. In addition, the vehicle manual database 223 includes all information about the vehicle 1.

Referring to FIG. 14, the dialog model database 224 may store the dialog model 900. The dialog model 900 may include a question about a sign in the vehicle and a response corresponding to the question. The dialog model 900 may be stored as text. The processor 210 may generate the dialog model 900 using the vehicle information database including the cluster information database 221, the AVN setting database 222, and the vehicle manual database 223. In addition, the processor 210 may determine a response corresponding to the question about the sign using the dialog model 900.

For example, the dialog model 900 includes “What is the engine warning light?” as a question about the sign in the vehicle, and may include “It is displayed by a warning light in the shape of a red kettle. The engine oil warning light turns on when the engine oil pressure is low.” as a response to this. When the user's voice input through microphone 120 includes the question “What is the engine warning light?,” the processor 210 may control the AVN device 140 to output a response saying “It is displayed by a warning light in the shape of a red kettle. The engine oil warning light turns on when the engine oil pressure is low.”

When the user's voice includes the question “What does the shape of the thermometer represent?,” the processor 210 may control the AVN device 140 to output a response saying “It is a coolant overheat warning light. If you continue to drive while ignoring the coolant overheat warning, it may cause engine overheat and cause malfunction due to engine head deformation.”

When the user's voice includes the question “What does the shape of the vehicle sliding represent?”, the processor 210 may control the AVN device 140 to output a response saying “It is ESP warning light. When the ESP warnings blink, it represents a situation where each wheel slips and the ESP device has intervened.”

When the user's voice includes the question “What does the fountain picture represent?”, the processor 210 may control the AVN device 140 to output a response saying “It is washer fluid warning light. Please fill the washer fluid because the washer fluid is insufficient.”

When the user's voice includes the question “What is the echo function?”, the processor 210 may control the AVN device 140 to output a response saying, “It is a function of controlling the output of rapid acceleration and sudden braking for economical driving and adjusting the gear stage focusing on fuel efficiency.”

When the user's voice includes the question “What is the arrow sign in the shape of A?”, the processor 210 may control the AVN device 140 to output a response saying “It is an auto stop/start function. It is a function that reduces fuel consumption by preventing idling, and is a function that turns off the engine when the vehicle stops.”

The questions and answers described in FIG. 14 are only examples, and the dialog model may include numerous questions and answers. Also, the dialog model may be learned. That is, the processor 210 may continuously update the dialog model.

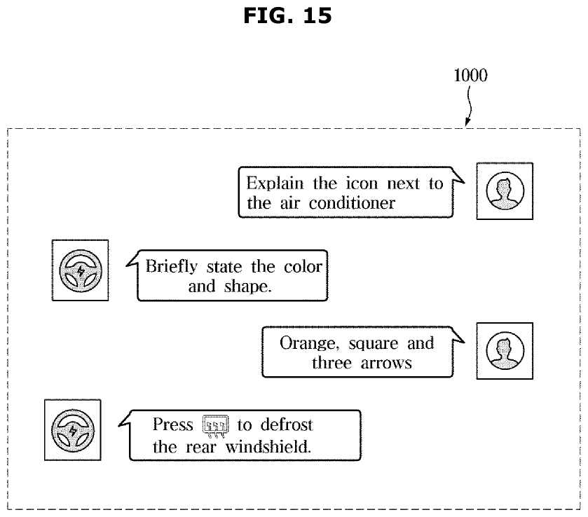

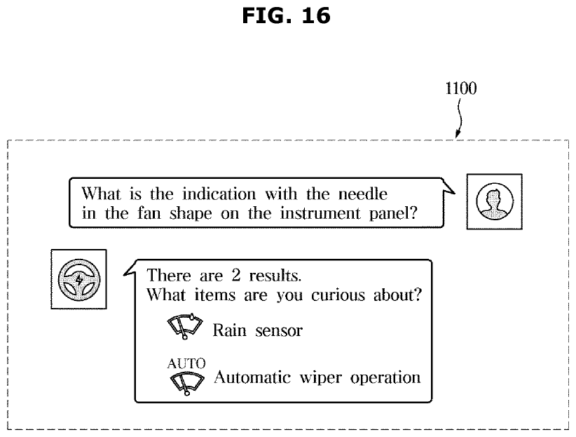

FIG. 15 illustrates an example of a screen displayed on a display by a control method of a vehicle according to an embodiment. FIG. 16 illustrates another example of a screen displayed on a display by a control method of a vehicle according to an embodiment.

Referring to the screen 1000 of the AVN device 140 shown in FIG. 15, the AVN device 140 may display a user voice including a question such as “Explain the icon next to the air conditioner” input through the microphone 120 as text. That is, the user's voice that describes the surrounding characteristic (e.g. surrounding device, surrounding sign) of the sign that is the object of the question may be input. The processor 210 may estimate the position of the sign that is the object of the question based on the surrounding characteristic of the sign that is the object of the question. In addition, the processor 210 of the vehicle control system 10 may control the AVN device 140 to output a response requesting a detailed characteristic of the sign. In response to this, the user may say something like “Orange, square and three arrows”. The processor 210 of the vehicle control system 10 may identify the characteristic words “orange”, “square” and “three arrows” about the sign from the user's utterance. The processor 210 may control the AVN device 140 to output a guide message together with an image of a sign matching the characteristic word with reference to the dialog model stored in the memory 220.

Referring to the screen 1100 of the AVN device 140 shown in FIG. 16, the AVN device 140 may display the user's voice including a question such as “What is the indication with the needle in the fan shape on the instrument panel?” input through the microphone 120 as text. The processor 210 of the vehicle control system 10 may identify from the user's utterance the characteristic words “fan shape” and “needle” about the sign. The processor 210 may find a sign matching the characteristic word with reference to the dialog model stored in the memory 220. When there are multiple matching signs, the processor 210 may control the AVN device 140 to output both an image of each matched sign and a description corresponding to each sign.

The disclosed embodiments of a vehicle control system and control method of a vehicle can efficiently and accurately provide information about a sign in a vehicle to a user using a voice recognition technology.

The disclosed embodiments of a vehicle control system and control method of a vehicle can provide information about the sign in the vehicle through free speech even if the user of the vehicle does not know the name of the sign in the vehicle. Accordingly, the user's understanding of the vehicle and service satisfaction can be improved.

Meanwhile, the disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be ROM, RAM, a magnetic tape, a magnetic disc, flash memory, an optical data storage device, etc.

The exemplary embodiments of the disclosure have thus far been described with reference to the accompanying drawings. It will be obvious to those of ordinary skill in the art that the disclosure may be practiced in other forms than the exemplary embodiments as described above without changing the technical idea or essential features of the disclosure. The disclosed embodiments are illustrative and should not be construed as limiting.

What is claimed is:

1. A vehicle control system comprising:
a display;
a microphone configured to acquire a user's voice;
a memory configured to store a dialog model related to a sign in a vehicle; and
a processor configured to identify a question about the sign in the vehicle in the user's voice, determine a response corresponding to the question about the sign using the dialog model, and control the display to output the determined response.

2. The vehicle control system of claim 1, wherein the processor is configured to identify a characteristic word about the sign in the question about the sign, and determine the response matching the characteristic word using the dialog model.

3. The vehicle control system of claim 1, further comprising a camera configured to acquire an image related to the sign in the vehicle, wherein the processor is configured to:
identify the sign from the image; and
generate the dialog model about the sign in the vehicle using the identified sign and a vehicle information database stored in the memory.

4. The vehicle control system of claim 3, wherein the processor is configured to:
extract a characteristic of the identified sign; and
extract vehicle information corresponding to the characteristic of the sign from the vehicle information database.

5. The vehicle control system of claim 4, wherein the processor is configured to:
generate a text representing the characteristic of the identified sign; and
search the vehicle information associated with the text representing the characteristic of the sign in the vehicle information database.

6. The vehicle control system of claim 5, wherein the processor is configured to generate the dialog model about the sign in the vehicle based on the searched vehicle information and the text representing the characteristic of the sign.

7. The vehicle control system of claim 4, wherein the processor is configured to extract at least one of color, shape, location or boundary of the identified sign as the characteristic of the identified sign.

8. The vehicle control system of claim 3, wherein the vehicle information database comprises a cluster information database, an AVN setting database, and a vehicle manual database.

9. The vehicle control system of claim 1, wherein the processor is configured to update the dialog model based on the question and the response about the sign.

10. A control method of a vehicle, the method comprising:
acquiring a user's voice through a microphone provided in the vehicle;
identifying a question about a sign in the vehicle in the user's voice;
determining a response corresponding to the question about the sign using a dialog model; and
controlling a display provided in the vehicle to output the determined response.

11. The method of claim 10, wherein determining the response corresponding to the question about the sign using the dialog model comprises:
identifying a characteristic word about the sign in the question about the sign; and
determining the response matching the characteristic word using the dialog model.

12. The method of claim 10, further comprising:
acquiring an image related to the sign in the vehicle by a camera provided in the vehicle;
identifying the sign from the image; and
generating the dialog model about the sign in the vehicle using the identified sign and a vehicle information database stored in a memory.

13. The method of claim 12, wherein generating the dialog model comprises:
extracting a characteristic of the identified sign; and
extracting vehicle information corresponding to the characteristic of the identified sign from the vehicle information database.

14. The method of claim 13, wherein extracting the vehicle information corresponding to the characteristic of the identified sign comprises:
generating a text representing the characteristic of the identified sign; and
searching the vehicle information associated with the text representing the characteristic of the identified sign in the vehicle information database.

15. The method of claim 14, wherein generating the dialog model is performed based on the text representing the characteristic of the identified sign and the searched vehicle information.

16. The method of claim 13, wherein extracting the characteristic of the identified sign comprises extracting at least one of color, shape, location or boundary of the identified sign.

17. The method of claim 12, wherein the vehicle information database comprises a cluster information database, an AVN setting database, and a vehicle manual database.

18. The method of claim 10, further comprising updating the dialog model based on the question and the response about the sign.

19. A vehicle comprising:
an instrument panel in an interior of the vehicle;
an audio/video/navigation (AVN) device in the interior of the vehicle, the AVN device including a display and a speaker;
an input device in the interior of the vehicle;
a microphone configured to acquire a user's voice;
a memory configured to store a dialog model related to a sign on the instrument panel in the vehicle; and
a processor configured to identify a question about the sign on the instrument panel in the vehicle in the user's voice, determine a response corresponding to the question about the sign using the dialog model, and control the display to output the determined response.

20. The vehicle of claim 19, wherein the processor is configured to identify a characteristic word about the sign in the question about the sign, and determine the response matching the characteristic word using the dialog model.
